(19) United States
(12) Patent Application Publication
(10) Pub. No.: US 2024/0408953 A1
(43) Pub. Date: Dec. 12, 2024

(54) ELECTRIC TRUCKS AND ASSOCIATED SYSTEMS

(71) Applicant: Telo Trucks Inc., San Francisco, CA (US)

(72) Inventors: Jason Murray MARKS, San Francisco, CA (US); Forrest North, Woodside, CA (US); David Osman Doluca, San Mateo, CA (US); Graham Kingston, Saratoga, CA (US)

(21) Appl. No.: 18/741,608

(22) Filed: Jun. 12, 2024

Related U.S. Application Data
(60) Provisional application No. 63/507,602, filed on Jun. 12, 2023.

(51) Int. Cl. B60K 1/04; B60L 50/60; B60R 19/12; B60R 21/0134; B60R 21/34; B60R 21/36; B62D 21/11; B62D 21/15; B62D 25/16; B62D 35/00

(52) U.S. Cl. CPC B60K 1/04; B60L 50/66; B60R 19/12; B60R 21/0134; B60R 21/36; B62D 21/11; B62D 21/15; B62D 25/16; B62D 35/008; B60R 2021/346

(57) ABSTRACT

Various systems and methods associated with an electric truck are described. In some embodiments, the electric truck includes a safety system that selects and performs safety actions (e.g., deployment of external air bags, activation of internal safety devices) based on a sensed or determined dangerous event. The safety system can, in some cases, determine a mode of deployment of one or more safety devices, and perform an action that deploys the safety devices based on the determined mode and/or based on the determined dangerous event (e.g., potential collision event).

### CROSS REFERENCE TO RELATED APPLICATIONS

This application claims priority to U.S. Provisional Patent Application No. 63/507,602, filed on Jun. 12, 2023, entitled ELECTRIC TRUCKS AND ASSOCIATED SYSTEMS, which is hereby incorporated by reference in its entirety.

### BACKGROUND

An electric vehicle (EV) utilizes an electric motor for propulsion. There are many types of EVs, including electric cars and trucks, electric trains, electric bicycles and other micro-mobility devices (e.g., scooters, skateboards, and so on), electric boats, electric aircraft, electric spacecraft, and others.

Electric trucks can be particularly useful to people, as they combine the benefits of an electric vehicle (low or zero emissions, low noise) with the utility of a truck (hauling, storage, power, and so on). However, current electric trucks are often simple electric versions of gas-powered trucks, and thus can suffer from drawbacks (e.g., too large for cities or other dense areas) that can prevent or limit their adoption by users.

### BRIEF DESCRIPTION OF THE DRAWINGS

Embodiments of the present technology will be described and explained through the use of the accompanying drawings.

FIGS. 1A-1B are diagrams illustrating an example electric truck.

FIGS. 1C-1D are diagrams illustrating an example electric truck and cap component.

FIG. 2 is a diagram illustrating an external airbag and associated safety system for an electric truck.

FIGS. 3A-3B are diagrams illustrating interactions between a safety system and components of an electric truck.

FIG. 4 is a flow diagram illustrating a method for performing a safety action.

FIGS. 5A-5B are flow diagrams illustrating a method for selecting a safety action to perform on behalf of an electric truck.

FIGS. 6A-6D are diagrams illustrating a platform for an electric truck.

FIGS. 7A-7C are diagrams illustrating a front area of a platform for an electric truck.

FIGS. 8A-8B are diagrams illustrating components of a breakaway configuration of a platform for an electric truck.

FIGS. 9A-9E are diagrams illustrating implementation of a breakaway configuration of a platform for an electric truck.

FIGS. 10A-10B are diagrams illustrating a battery pack for an electric truck.

FIGS. 11A-11B are diagrams illustrating a venting system for an electric truck.

FIGS. 12A-12B are diagrams illustrating a reconfigurable bed for an electric truck.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods associated with an electric truck are described. In some embodiments, the electric truck includes a safety system that selects and performs safety actions (e.g., deployment of external airbags, activation of internal safety devices) based on a sensed or determined dangerous event (e.g., a potential collision event). The safety system can, in some cases, determine a mode of deployment of one or more safety devices, and perform an action that deploys the safety devices based on the determined mode and/or based on the determined dangerous event (e.g., potential collision event).

In some embodiments, the electric truck includes a breakaway front section that operates, along with an external airbag or airbags, to crumple or otherwise break away during a collision or impact with an object.

In some embodiments, the electric truck includes or is supported by a platform, such as a “skateboard” style platform, which supports various structures or areas of the truck. The platform can facilitate the configuration or use of different truck modules or components, enabling the truck to provide the functionality of a truck (e.g., a bed for hauling objects, power to tow objects) while maintaining a length that is comparable to a car (e.g., 13-14 feet in length).

While described herein with respect to electric trucks, in some embodiments aspects of the technology described herein can be configured or utilized with other electric vehicles, such as electric cars, wheeled micro-mobility vehicles, and so on.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of an Electric Truck

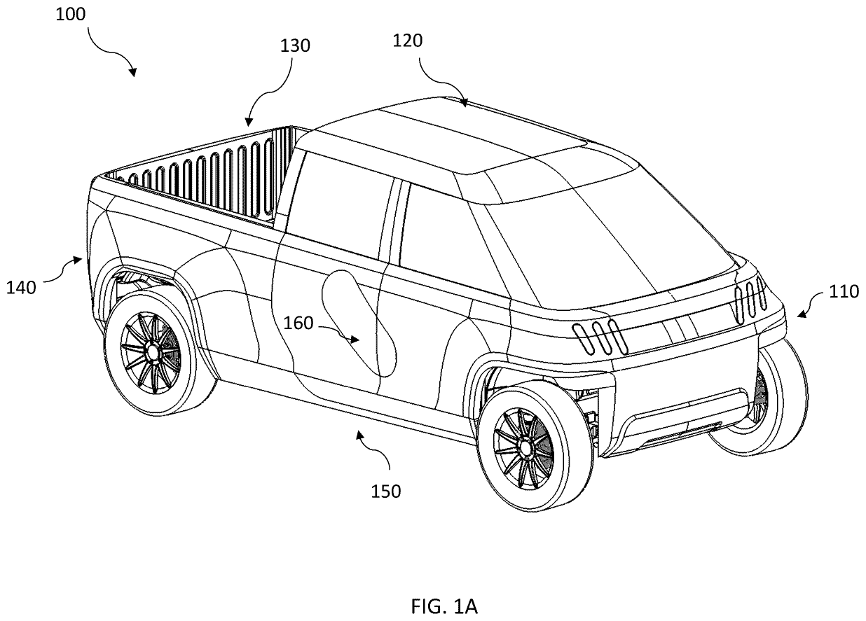

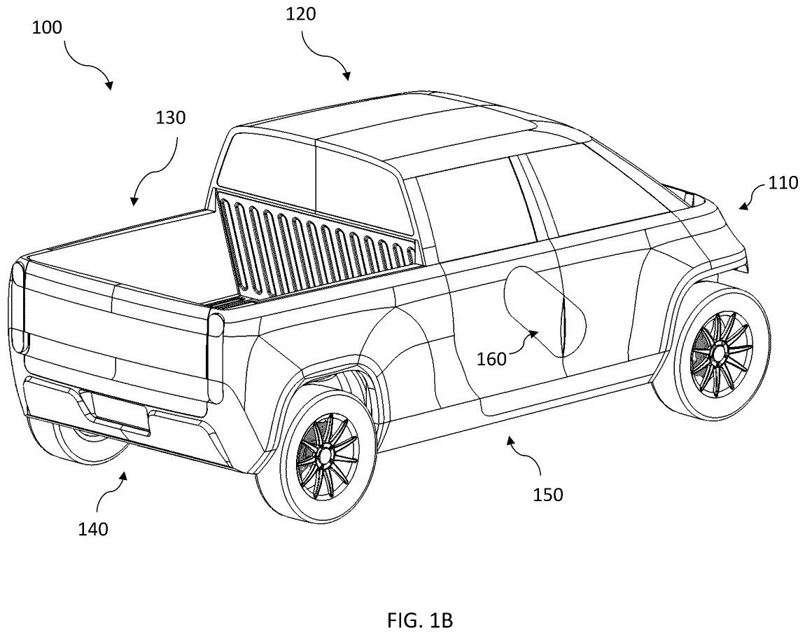

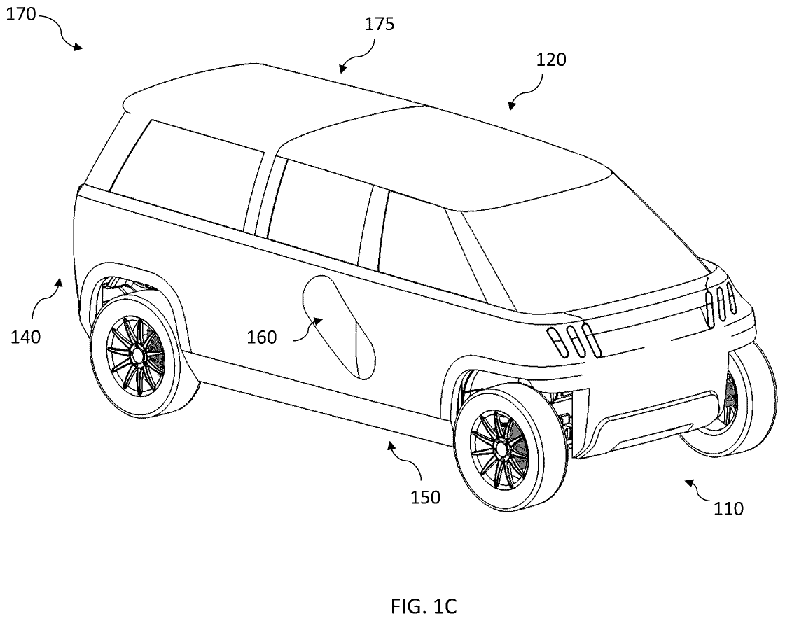

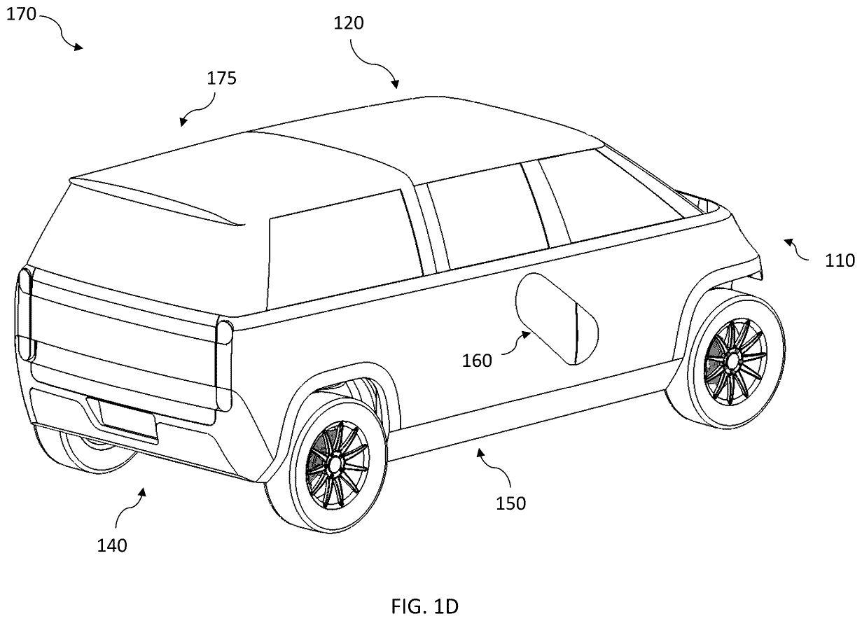

As described herein, an electric truck, and associated systems, is described. FIGS. 1A-1B are diagrams illustrating an example electric truck 100. The electric truck 100 includes a front area 110 or subframe, which contains an electric drivetrain or motor driven by an electric battery. The electric truck 100 also includes a cab 120 (e.g., a four-door cab), a truck bed 130 (e.g., which can be configurable, as described herein), a rear area 140, which can also include components of an electric drivetrain or motor, and a frame, chassis, or platform 150 upon which the cab 120 and various components of the electric truck 100 are disposed.

As described herein, the electric truck 100 can have a length that is typical of most cars, such as a length of 13-14 feet. As shown, the front area 110 of the electric truck 100 does not add additional length to the truck, because the drivetrain, battery, and other components are disposed at other locations within the truck or are located under a footwell of the front area 110.

In some embodiments, the cab 120 of the electric truck 100 includes vents 160 or air flow openings, which assist in the flow of air from the front area 110 of the electric truck 100 to the rear of the truck and out of the vents 160. For example, as described herein, the vents 160 are positioned at a height that facilitates the flow of air through open wheel wells of the front area 110 of the electric truck 100 and out of the vents 160 on the side of the cab 120 of the electric truck 100.

FIGS. 1C-1D depict an electric truck 170 with an attached cap 175, such as a cap that covers and protects the bed 130 of the truck. In some cases, as described herein, the bed 130 is configurable, and the cap 175 can be attached when the bed 130 is carrying certain cargo or objects and/or is being used to transport passengers or pets (via an additional row of seats).

### Examples of a Safety System

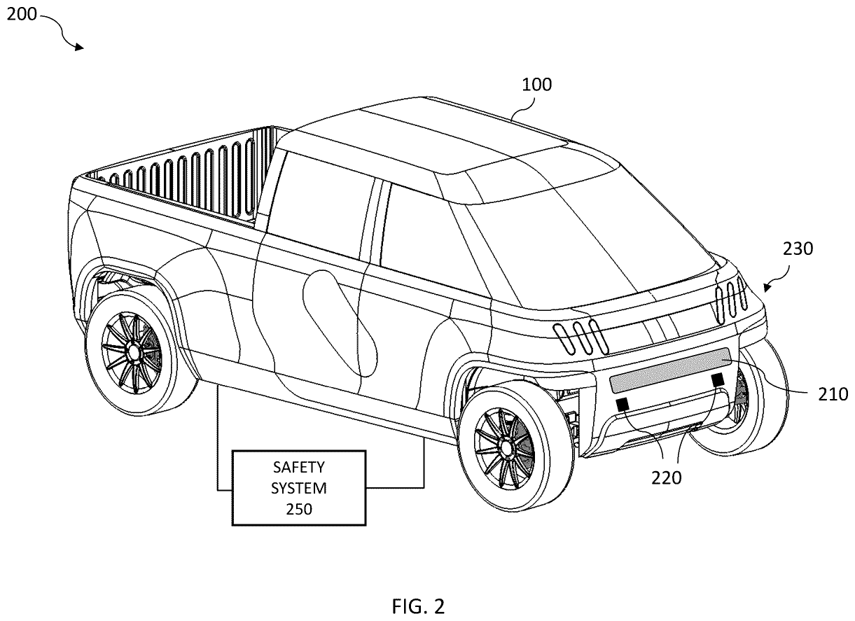

As described herein, in some embodiments, the electric truck (e.g., the electric truck 100 or 170) can include or utilize a safety system that performs actions in response to various events or activities (e.g., dangerous events or potentially dangerous events within an environment within which the truck is traveling). FIG. 2 is a diagram 200 illustrating a safety system 250 for the electric truck 100.

The components and/or modules of the safety system 250 can be implemented with a combination of software (e.g., executable instructions, or computer code) and hardware (e.g., at least a memory and processor). Accordingly, as used herein, in some example embodiments, a component/module is a processor-implemented component/module and represents a computing device having a processor that is at least temporarily configured and/or programmed by executable instructions stored in memory to perform one or more of the functions that are described herein.

The safety system 250 can be part of or implemented by a computing system of the electric truck 100, 170. For example, the computing system can implement a controller area network, or CAN (CAN-HS), or CAN bus, which facilitates communications between various devices or systems, such as Electronic Control Units (ECUs). Thus, ECUs of the system (or that implement aspects of the system 250), can communicate via the CAN or a similar protocol, such as LIN, FlexRay, an automotive ethernet, and so on. Further, the various devices can utilize 1000Base-T1 communications, GMSL or FPD-Links (e.g., versions of MIPI CSI-2), DSI, and so on.

The safety system 250 the electric truck 100 can receive input from a variety of different sensors or devices over various communications protocols or links, and provide instructions or information to various output devices, such as actuators, using the protocols or links.

The electric truck 100 can include one or more deployable airbags 210 located in or on an external area of the electric truck 100 (e.g., an external surface 230 of a front area of the electric truck 100). The electric truck 100 can also include different sensors 220 (e.g., three-dimensional (3D) imaging radar sensors, Lidar (light detection and ranging) sensors, cameras, image sensors, and so on) that monitor a space or environment within which the truck 100 travels (e.g., the area in front of the truck 100) and provide captured information to the safety system 250. The safety system 250, using the captured information, can perform actions, such as deploying the airbags 210 (e.g., in a multi-stage deployment) or other safety devices located within or outside of the truck 100.

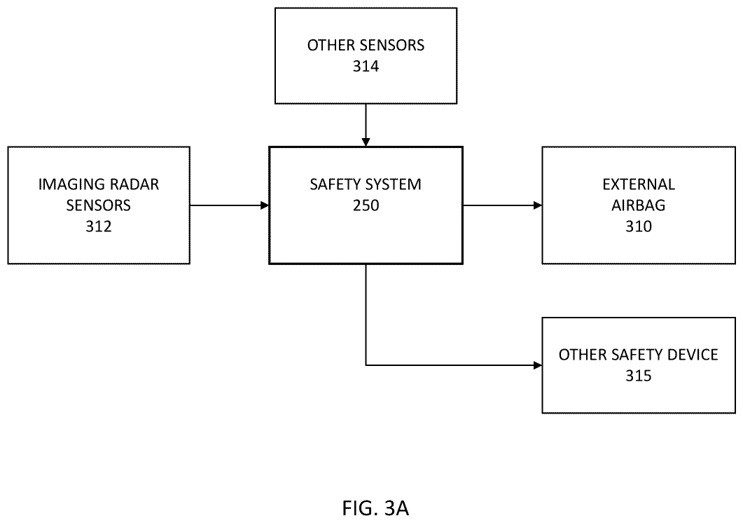

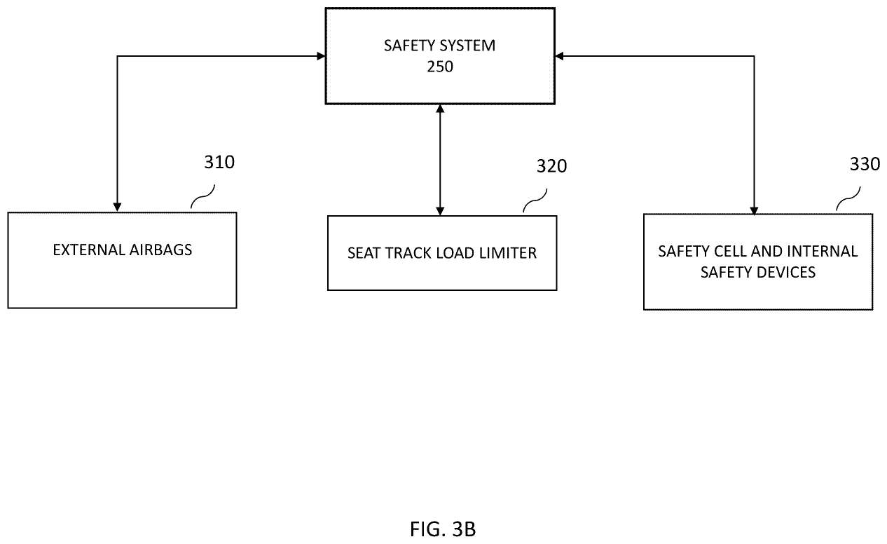

In some embodiments, as shown in FIG. 3A, the safety system 250 may capture and utilize information captured by other devices or sensors 314, in addition to data captured by imaging radar sensors 312. Examples of such information or data incudes speed or acceleration information, weather or environmental information, GPS or location information, traffic information, vehicle condition information (e.g., information that indicates wear to the tires or brakes of the truck 100), and so on. Using the information, the safety system 250 can selectively deploy an external airbag 310 and/or other safety devices 315.

Using the various types of information, the safety system 250 can select and perform safety actions that are targeted and determined based on a current or potential event at the truck 100, in order to protect both passengers within the truck 100 and pedestrians or objects outside of the truck 100. For example, as depicted in FIG. 3B, the safety system 250 can deploy one or more of the external airbags 310 (e.g., assembled or disposed on a front bumper or beam), a seat track load limiter 320 (which limits acceleration of passengers within a vehicle), and/or safety cells or internal safety devices 330 (which can include internal crumple zones, internal airbags, safety cells, collapsible steering wheels, seatbelt pretensioners, and so on).

Thus, the electric truck 100 can utilize the safety system 250 to provide its passengers with an enhanced and dynamically determined safety deployment, despite the electric truck 100 not having a traditional hood structure in the front area of the electric truck 100.

In some embodiments, the safety system 250 selects and performs safety actions (e.g., deployment of external air bags, activation of internal safety devices) based on a sensed or determined dangerous event (e.g., a potential collision). The safety system can, in some cases, determine a mode of deployment of one or more safety devices, and perform an action that deploys the safety devices based on the determined mode.

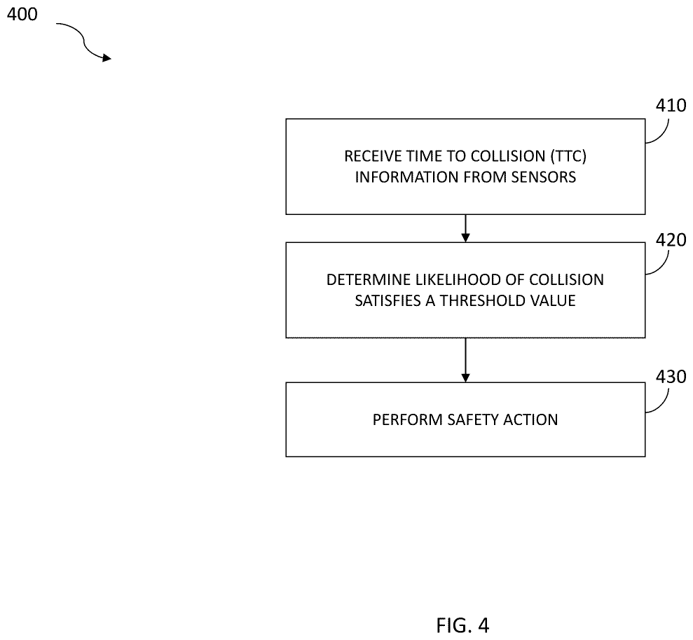

FIG. 4 is a flow diagram illustrating a method 400 for performing a safety action for an electric vehicle, such as the electric truck 100. The method 400 may be performed by the safety system 250 and, accordingly, is described herein merely by way of reference thereto. It will be appreciated that the method 400 may be performed on any suitable hardware.

In operation 410, the safety system 250 receives time to collision (TTC) information from one or more sensors of the electric truck 100. For example, the safety system 250 can receive TTC information for an object in front of the electric truck 100 and from 3D imaging radar sensors located at a front area of the electric truck 100.

In operation 420, the safety system 250 determines a likelihood of collision satisfies a threshold value. For example, the safety system 250 may determine, based on the TTC information, that there is a likelihood of collision with the object (e.g., a pedestrian, a vehicle, a road object, and so on) in front of the electric truck 100 when the TTC information indicates a time that is less than a threshold value to perform one or more safety actions.

In operation 430, the safety system 250 performs a safety action. For example, the safety system 250 may cause external airbags to deploy in one or more stages, in response to determining the TTC satisfies the threshold value.

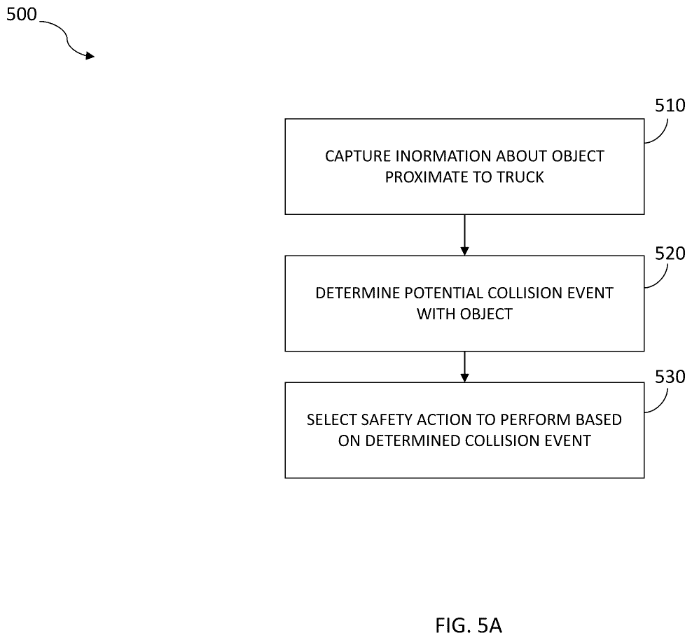

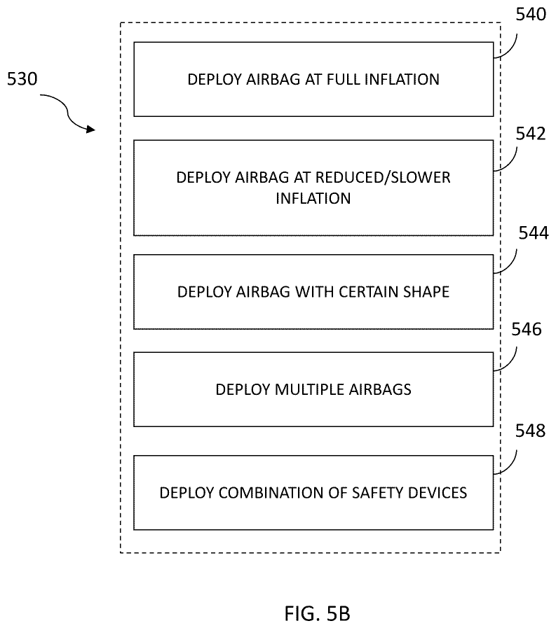

FIGS. 5A-5B are flow diagrams illustrating a method 500 for selection a safety action to perform on behalf of an electric truck. The method 500 may be performed by the safety system 250 and, accordingly, is described herein merely by way of reference thereto. It will be appreciated that the method 500 may be performed on any suitable hardware.

In operation 510, the safety system 250 captures information about an object proximate to the electric truck 100. For example, the safety system 250 can receive information (e.g., 3D imaging, such as a 3D point cloud image) that depicts or represents an object proximate to the electric truck 100.

In operation 520, the safety system 250 determines a potential collision event with the object. For example, as described in FIG. 4, the safety system 250 may determine whether a TTC with the object satisfies a threshold value (e.g., is lower than a minimum TTC for performing a safety action).

In operation 530, the safety system 250 selects a safety action to perform based on the determined collision event and/or the based on an identification of the object. For example, safety system 250, as depicted in FIG. 5B, may select one or more safety actions to perform, including:

Deployment of an airbag at full inflation 540;

Deployment of an airbag at a reduced or slower inflation 542;

Deployment of an airbag having a certain shape or geometry 544;

Deployment of multiple airbags (an array of airbags) 546, either at full, reduced, or staggered inflations (e.g., multiple charges); and/or

Deployment of a combination of safety devices 548, such as those described herein.

For example, when the safety system 250 determines the electric truck 100 is going to imminently hit a road object (a guard rail or another vehicle), the system 250 may select to fully deploy an airbag. However, as another example, when the safety system 250 determines the electric truck 100 is potentially going to hit a pedestrian, the system 250 may select to partially inflate the airbag (e.g., to reduce a hard impact to the pedestrian), while also deploying internal devices to protect passengers of the electric truck 100.

Thus, in various embodiments, the safety system 250 can employ or provide an advanced driver-assist system (ADAS) that is optimized and/or enhanced for specific KPIs, including airbag deployment (e.g., single or multi-stage deployment). The safety system 250, as described herein, can determine and/or select safety actions based on Time to Collision (TTC) information (e.g., a floating point representation in ms), Likelihood of Collision (LoC) information (e.g., floating point between 0 and 1), Size of Collision (SoC) information (e.g., floating point between 0 and 1), Type of Object in Collision (ToO) information (e.g., Enum), Speed and Orientation of Object (VoC) information (e.g., Vector), Amplitude of Deployment (AoD) information (e.g., floating point between 0 and 1), Speed of Deflation (SoD) information (e.g., Enum), type of airbag materials or shapes, and so on.

The components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The devices or systems may communicate over any network, ranging from a wired or wireless local area network (LAN), to a wired or wireless wide area network (WAN), to the Internet or some other public or private network, to a cellular (e.g., 4G, LTE, 5G, 6G network), and so on. While the connections between the various devices and the network and are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server or cloud-based computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, AR/VR devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or pre-programmed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

### Examples of a Platform for an Electric Truck

As described herein, in some embodiments, the electric truck includes or is supported by a platform, such as a “skateboard” style platform or chassis, which supports various structures, loads, and/or areas of the electric truck. The platform can facilitate the configuration or use of different truck modules or components, enabling the truck to provide the functionality of a truck (e.g., a bed for hauling objects, power to tow objects) while maintaining a length that is comparable to a car (e.g., 13-14 feet in length).

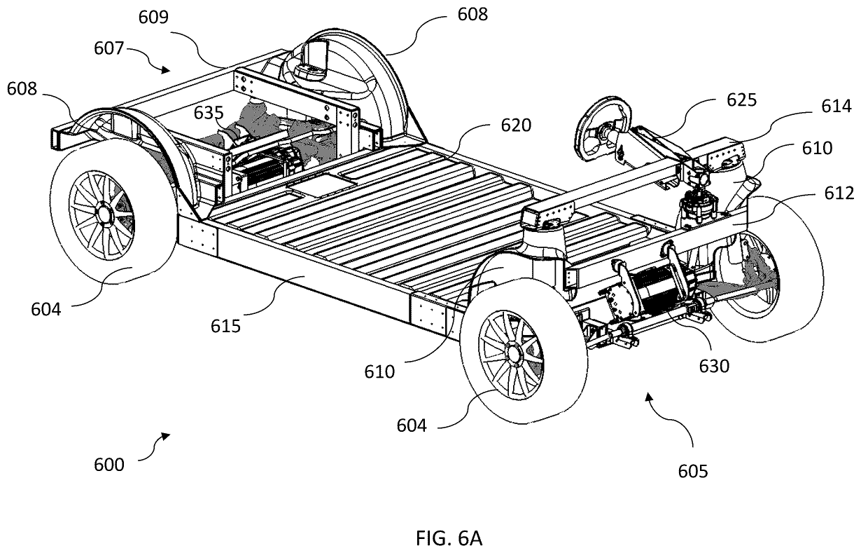

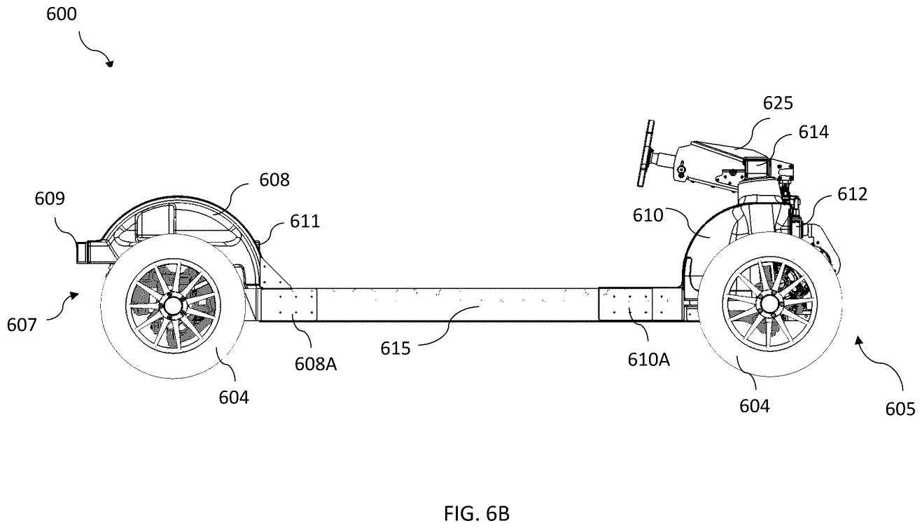

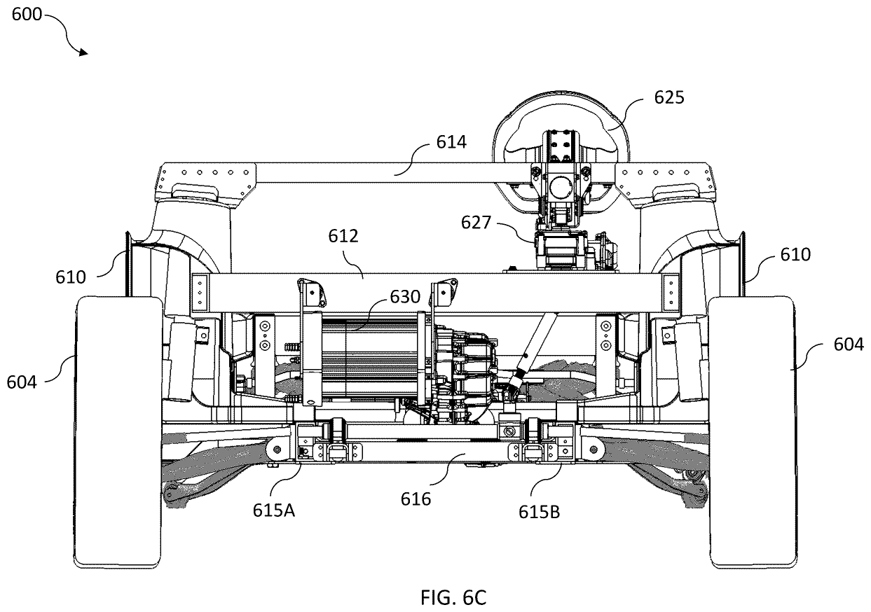

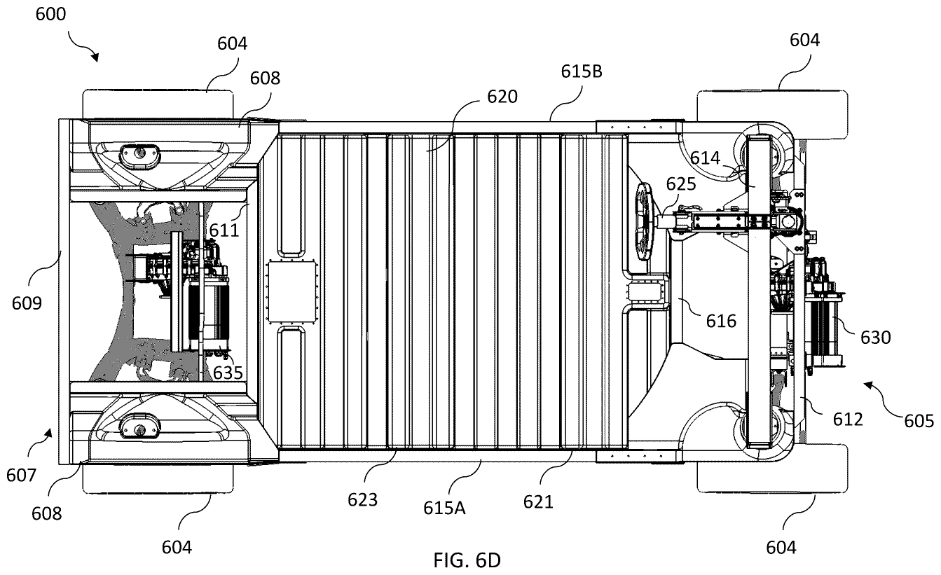

FIGS. 6A-6D are diagrams illustrating a platform 600 for an electric truck. The platform, in some embodiments, includes a quarter monocoque construction, where the chassis of the truck is at least partially integrated with the body of the truck. For example, as depicted, the platform 600 includes four composite wheel wells (e.g., two front wheel wells 610 and two rear wheel wells 608) connected to straight frame extrusions 615 (e.g., aluminum extrusions). Thus, in some cases, the platform 600 provides a modular structure or chassis for an electric truck.

The front wheel wells 610, located at a front area 605 of the platform 600, are a rigid structural element of the platform 600 (and, thus, the truck or vehicle that is supported by the platform 600). The front wheel wells 610 include wheels 604 and connect the frame, a front subframe, a footwell, a top of a MacPherson strut, an A-Pillar, front crash safety components, a front bumper, and/or a body of the truck or vehicle. The front wheel wells 610 can be optimized or configured for vehicle ingress and egress, such as by adhering to an exterior perimeter of tire motion (with space for debris) and for providing footwell horizontal space for passengers.

The front area 605 includes a first front straight frame extrusion 614 that connects a top portion of a right front wheel well 610 to a top portion of a left front wheel well 610 and a second front straight frame extrusion 612 that connects a lower portion of the right front wheel well 610 to a lower portion of the left front wheel well 610. The front area 605 also includes a third front straight frame extrusion 616 that connects a front portion 615A of the right straight frame extrusion 615 to a front portion 615B of the left straight frame extrusion 615.

A steering assembly 625 is disposed and/or mounted to the first front straight frame extrusion 614 and may include various power steering components 627. Further, a motor package 630 is disposed and/or mounted below the second front straight frame extrusion 612.

Similarly, the rear wheel wells 608, located at a rear area 607 of the platform 600, are a rigid structural element of the platform 600 (and, thus, the truck or vehicle that is supported by the platform 600). The rear wheel wells 608 include wheels 604 and connect the frame, a rear subframe, a top of a rear strut (in a multilink or 4-bar suspension), a rear bumper, bed mounts, and/or body mounts of the truck. The rear wheel wells 608 can be optimized or configured for maximum bed space and can include an internal or hidden (locked) luggage or storage compartment.

The rear area 607 includes a first rear straight frame extrusion 609 that connects a rear portion of a right rear wheel well 608 to a rear portion of a left rear wheel well 608 and a second rear straight frame extrusion 611 that connects an inner portion of the right rear wheel well 608 to an inner portion of the left rear wheel well 608. A rear motor package 635 may be disposed or located between the rear wheel wells 608 and the rear straight frame extrusions 609, 611.

In some embodiments, the wheel wells (e.g., front wheel wells 610 and/or rear wheel wells 608) may be formed of structural carbon or similar composite, while the frame extrusions are formed of aluminum or other similar metals. However, aspects of the wheel wells or extrusions may also be formed of structural carbon, such as interface sections 608A, 610A, which connect, couple, and/or interface between the wheel wells and the frame extrusions.

A battery package 620, such as a flat electric battery, may be disposed and/or mounted within the platform 600, such as between the wheel wells and the frame extrusions. The battery package 620 may include mount structures 621, 623, which facilitate the mounting of seats (e.g., rear seats and front seats) to the platform 600. Thus, the battery package 620 may fit within the platform 600 such that a top surface of the battery package 620 does not extend above the frame extrusions, providing a surface for mounting seats or other internal components of an electric truck (e.g., with battery cells located on a bottom surface of the platform, as is described herein).

Thus, in some embodiments, the platform 600 may facilitate the mounting of the front motor package 630 disposed below the front straight frame extrusion of the front area (e.g., the second front straight frame extrusion 612), the rear motor package 635 disposed between the two rear wheel wells 608 of the rear area 607, and electric battery or battery package 620 disposed between right and left straight frame extrusions 615A, 615B of the platform 600. The platform 600, therefore, may enable or provide powertrain packages in a front and/or rear area of the electric truck, facilitating a larger bed geometry (e.g., a 49-inch-wide bed at its narrowest), as well as a shorter front area, among other benefits.

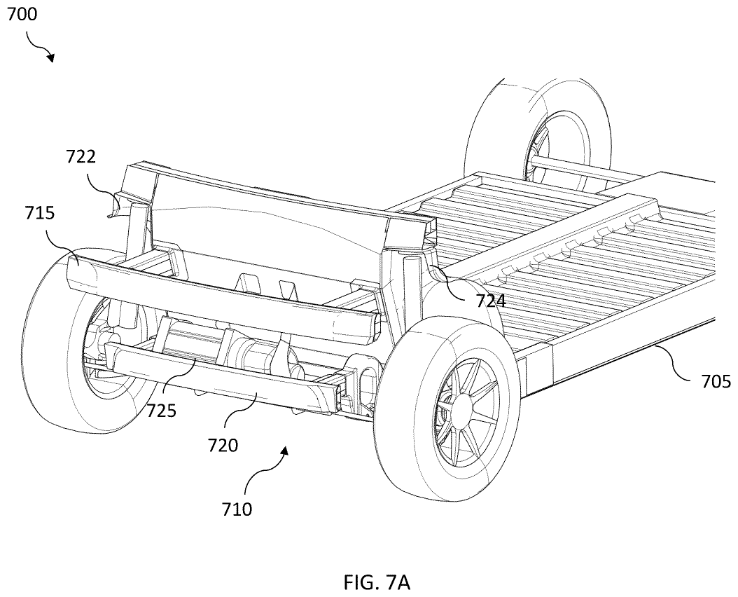

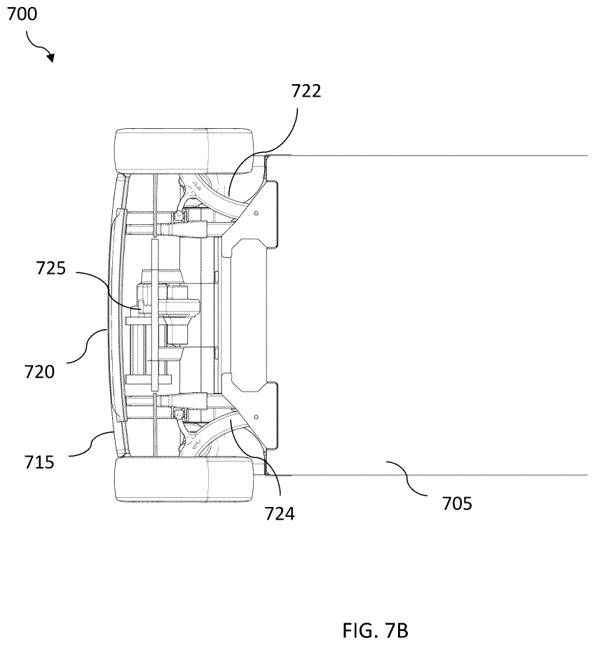

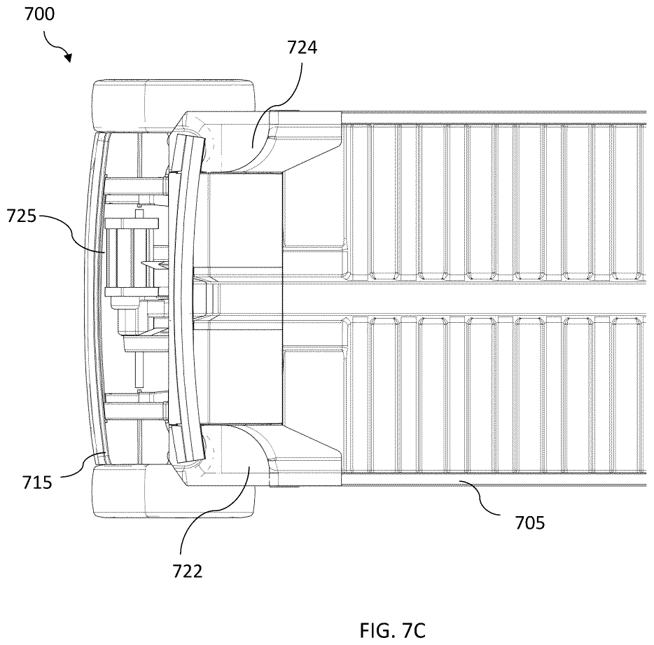

In some embodiments, the front area 605 provides a breakaway section during collisions or other impact events. FIGS. 7A-7C are diagrams illustrating a front area 710 of a platform 700 for an electric truck having a front crash structure, where FIG. 7A depicts a perspective view, FIG. 7B depicts a bottom view, and FIG. 7C depicts a top view of the platform 700. The front area 710 may include a front subframe coupled to straight extrusions 705 of the platform 700 and contain the front crash structure, which crumples under the platform 700 in response to striking or colliding with an object.

The front area 710 includes a primary bumper beam 715 and a secondary bumper beam 720. The primary bumper beam 715 functions as a primary load path for forces imparted onto the platform 700 by any collisions or objects that impact the platform, and the secondary bumper beam 720, which is positioned in front of a motor package 725, acts a secondary load path for the imparted forces. The beams 715, 720 may be formed as an aluminum extrusion and may include an expanded polypropylene (EPP) layer that is positioned and/or configured to absorb energy transferred to the platform 700 during a crash/collision/impact.

In some cases, the wheel wells (e.g., a right wheel well 722 and a left wheel well 724) may be formed of a carbon fiber reinforced plastic (CFRP) or a similar material that reacts to forces imparted through the front area 710 to a passenger compartment located behind the wheel wells. The wheel wells, therefore, are formed to react to the forces and protect occupants during a collision or impact.

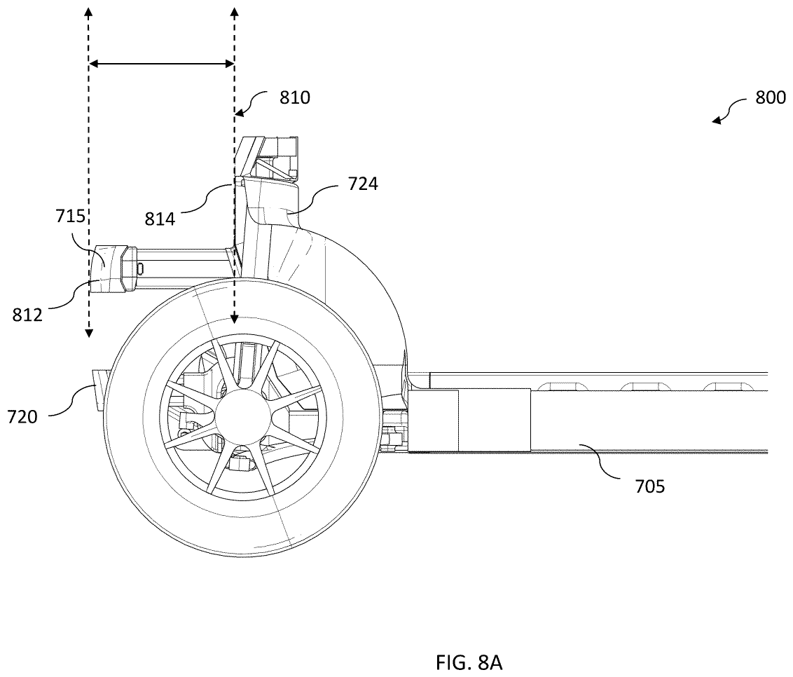

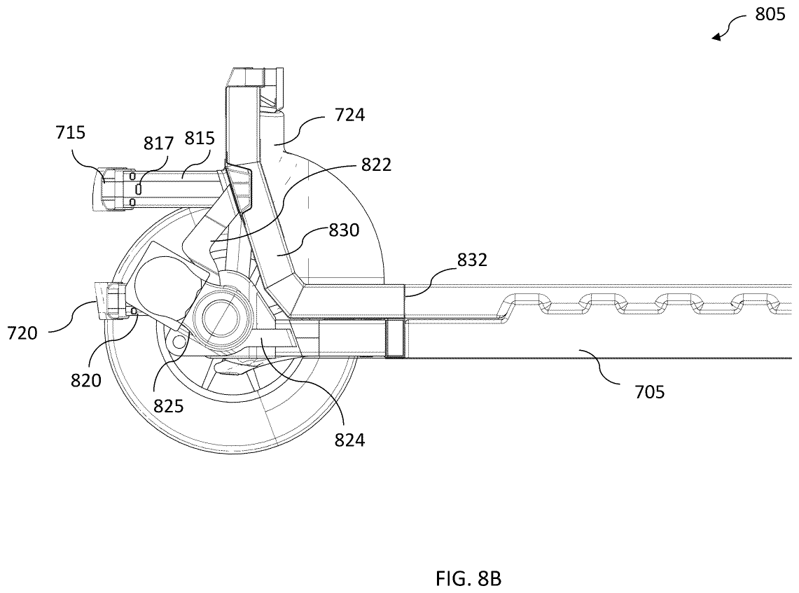

FIG. 8A is a diagram 800 depicting a crumple zone 810 of the front area 710 of the platform 700. The crumple zone, which may have width of approximately 14 inches (e.g., 13-16 inches), is formed by the positions/locations of a front end 812 of the primary bumper beam 715 with respect to a passenger compartment firewall 814. In some cases, the size of the crumple zone 810 is configured to provide certain performance characteristics during an impact or crash. For example, the components of the front area 710 may dampen forces applied during impact, yet the crumple zone 810, having the minimum size and being associated with the configuration of components, maintains a certain buffer of space for occupants of the electric truck during its deformation due to the impact or crash.

Thus, in some cases, the front area 710 may be configured and/or structured to incorporate a minimum width for a suitable crumple area and dispose other components within the front area 710 to maintain a total length or dimension of the front area 710 that minimally exceeds the width of the crumple zone 810. In doing so, the platform 700 enables an electric vehicle or truck to provide a desired overall length (e.g., lesser than a typical truck), without compromising its safety or protective features, among other benefits.

FIG. 8B is a diagram 805 depicting additional components of the front crash structure of the front area 710 of the platform 700. A primary energy absorber 815, or crash can (one on each side of the platform 700) supports or is part of the primary bumper beam 715. A secondary energy absorber 820, or crash can (one on each side of the platform 700) supports or is part of the secondary bumper beam 720. Each of the energy absorbers may be aluminum extrusion based and include crush initiators 817, which are located in a staggered pattern within the energy absorbers.

A motor package 825, which may be a space-efficient traction motor (e.g., having a low center-of-gravity height), is supported and/or positioned via subframe components 822, 824. The subframe components 822, 824, or motor mount components, may be shear-able and/or move in a controlled failure mode during an impact or crash (e.g., when high forces are applied). As discussed herein, the motor package 825 is mounted via the subframe components 822, 824 such that the motor package 825 deflects or otherwise moves with control below a passenger compartment (e.g., the space above the frame extrusion 705) during a collision or impact.

A spine 830, or similar structural element, provides a rigid structure that provides an additional load path for forces applied to the platform 700 during an impact or collision. The spine 830, which is coupled to a battery package or frame extrusion via an interface 832, may receive applied forces while maintaining structural integrity during an impact or collision, protecting the passenger compartment from the parts or components being deflected during the impact or collision.

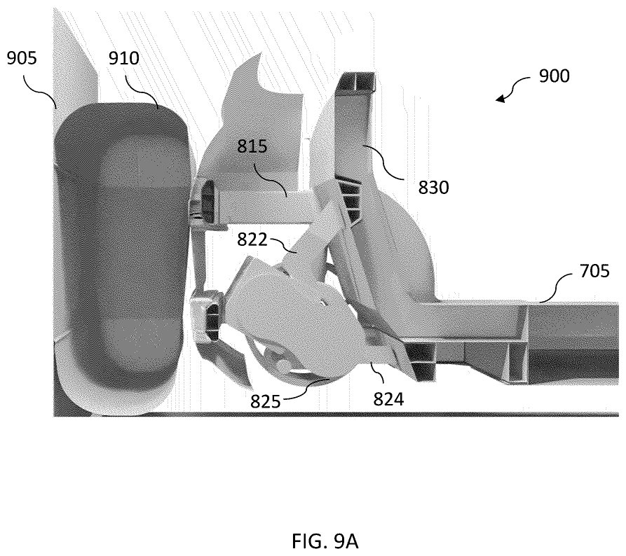

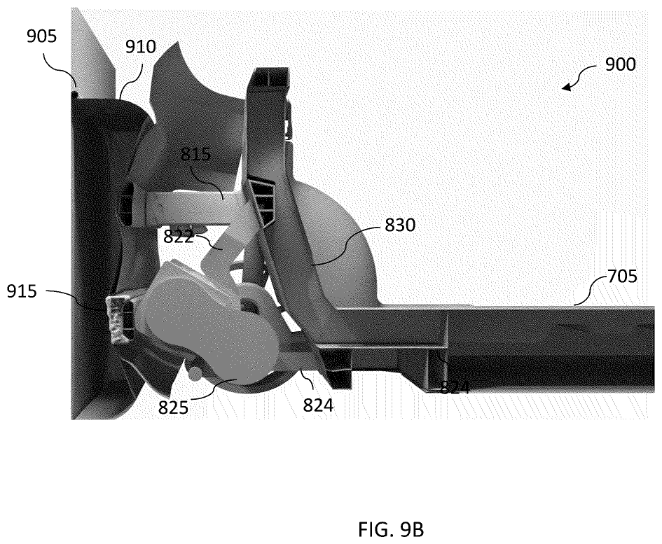

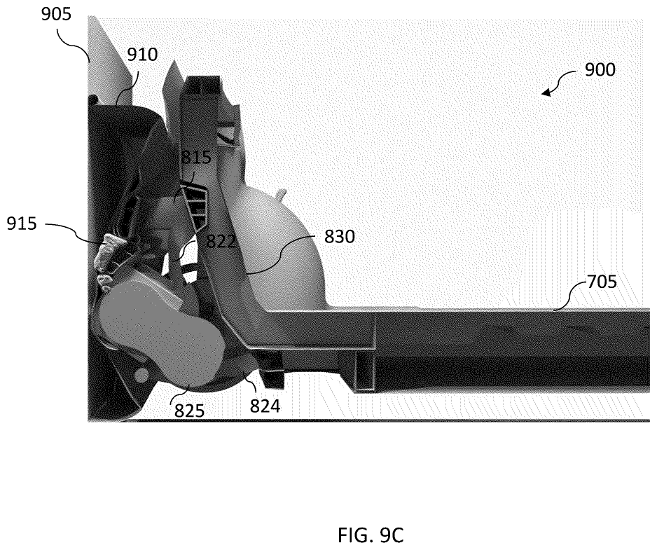

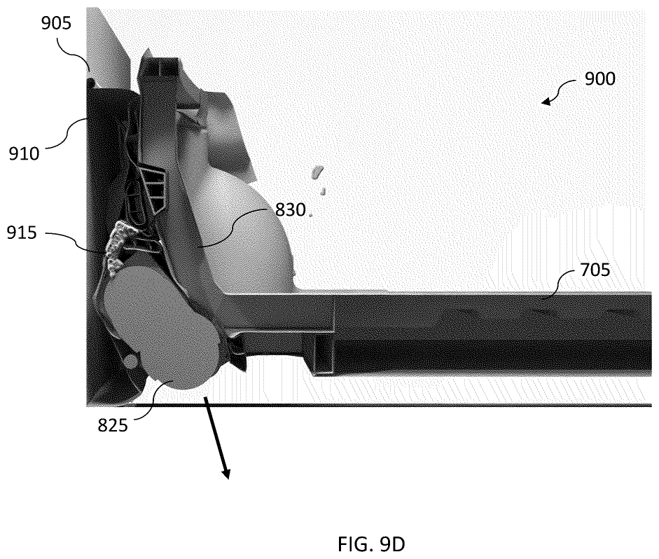

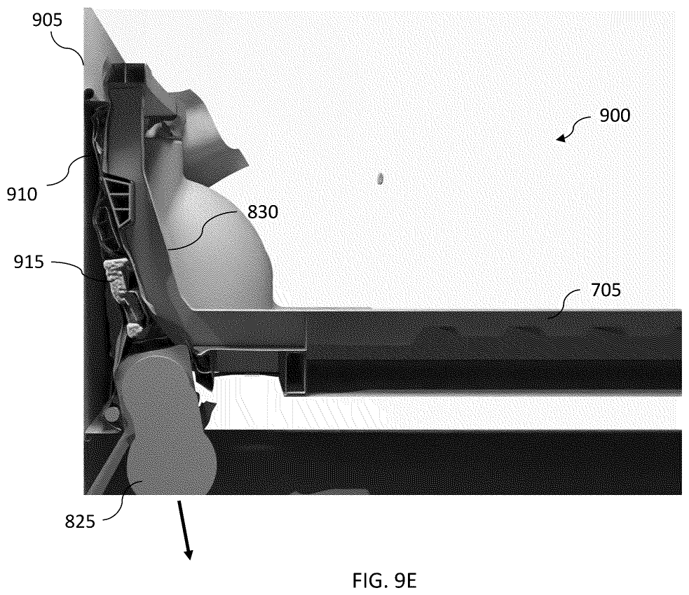

FIGS. 9A-9E are diagrams illustrating implementation of a breakaway configuration 900 of a platform for an electric truck. In FIG. 9A, in response to detection of a potential collision and/or an initial impact (e.g., when the safety system 250 performs an action in response to a detected dangerous event), an external airbag 910 is deployed, impacting a wall 905 (or another object).

In FIG. 9B, a crush initiation occurs on the primary energy absorber 815 and the secondary energy absorber 820. An EPP layer 915 of the secondary energy absorber 820 may also absorb energy from the impact.

In FIG. 9C, the external airbag 910 has completed its deceleration, and the subframe components 822, 824 begin to shear or move in a controller failure mode. Next, as shown in FIG. 9D, the shearing of the subframe components 822, 824 causes the motor package 825 to rotate (e.g., in a clockwise manner) and translate downwards (e.g., is guided or bounded, in part, by the spine 830).

Finally, as shown in FIG. 9E, the motor package 825 (e.g., along with steering packages or components) travels or moves below the passenger compartment of the platform 700 and away from any passengers or occupants. Thus, the various components of the crash structure facilitate an electric truck to provide a short or limited crumple zone or front area width while providing a safe structure for front vehicle impacts, among other benefits.

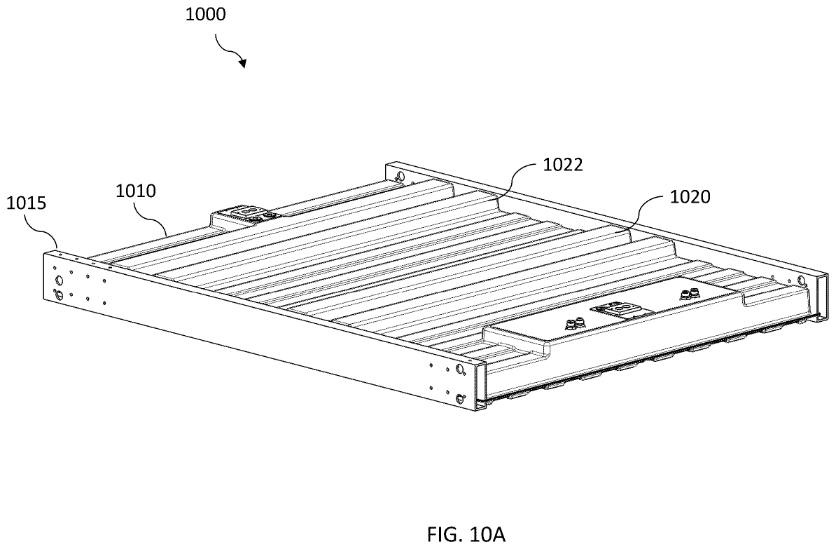

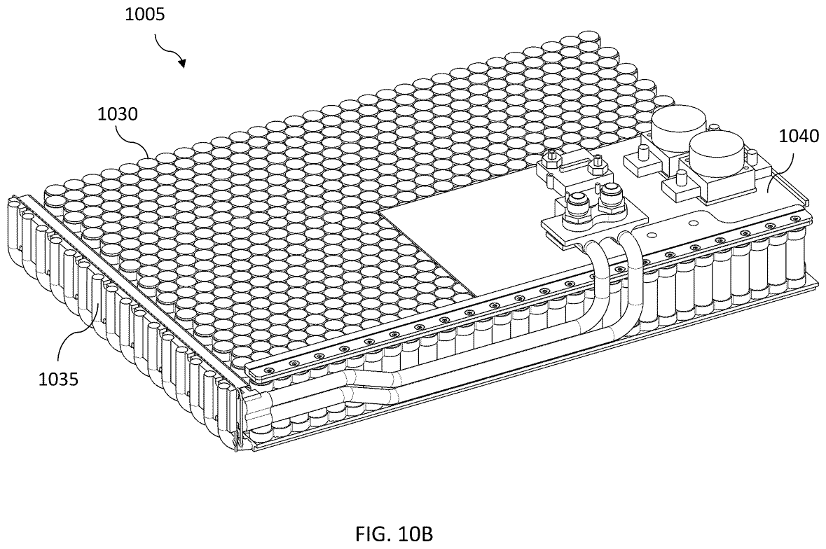

FIGS. 10A-10B are diagrams illustrating a battery pack 1000 for an electric truck. The battery pack 1000 may be a flat, space efficient, battery package, providing, for example, 300-400 Wh/L, or greater, of power to the truck. In some embodiments, the battery pack 1000 is a Vertical Height Optimized Battery Pack (VHO Battery Pack), which utilizes CellLink material to act as current collector, bus bars, data lines, and battery management system (BMS) lines for a BMS of the battery pack.

The battery pack 1000 may include multiple battery modules 1005 (shown in FIG. 10B), such as eight battery modules 1005. The battery module 1005 may include a contactor 1040, a main board, a BMS, and multiple battery cells 1030.

A top surface 1010 of the battery pack 100 may include seat mounts 1020, 1022, or other mounting components, and have a structure that includes frame extrusions 1015 and/or can be coupled or connected to the frame extrusions of the platform of the electric truck, as described herein. For example, the top surface 1010 of the battery pack 1000 may include a carbon fiber battery clamshell (e.g., two pieces), which can provide a rigid housing, space for battery expansion, space for collision protection, where the clamshell has integrated seat, floor, and bed mounts. The bottom of the clamshell may be aerodynamically efficient and mount a skid plate flush to its topology.

In some embodiments, the battery pack 1000 is laser welded to a single side, which leaves the bottom free for cooling, adding, for example, 1 mm of extra vertical height to the overall battery height. For example, using the Cell Link created material, the battery pack 1000 may individually fuse each battery cell 1030, which are disposed on a bottom surface of the battery pack 1000.

In some cases, the battery pack 1000 can be manufactured using a jig or similar structure, which can provide efficiencies in manufacturing (e.g., the pack is manufactured in its enclosure). For additional details, see U.S. patent application Ser. No. 17/542,190, filed on Dec. 3, 2021, entitled MANUFACTURING A BATTERY PACK USING A WELDING JIG, which is hereby incorporated by reference in its entirety.

In some cases, the battery pack 1000 includes a small cooling plate to extract heat out of the bottom cells 1030 of the pack, where coolant lines or tubes 1035 enter and exit between modules through the center of the vehicle (and not on the exterior of the vehicle). The coolant plate may use thin, flat channels optimized for coolant flow, and in some cases, may be 1 cm thick or smaller. In some cases, the battery pack 1000 includes electrically insulative, thermally conductive material between the bottom of the cells 1035 and cooling plate (which can include SilPad material, thermal epoxy, and so on), and optimized cell packaging (e.g., 1 mm air gaps between cells).

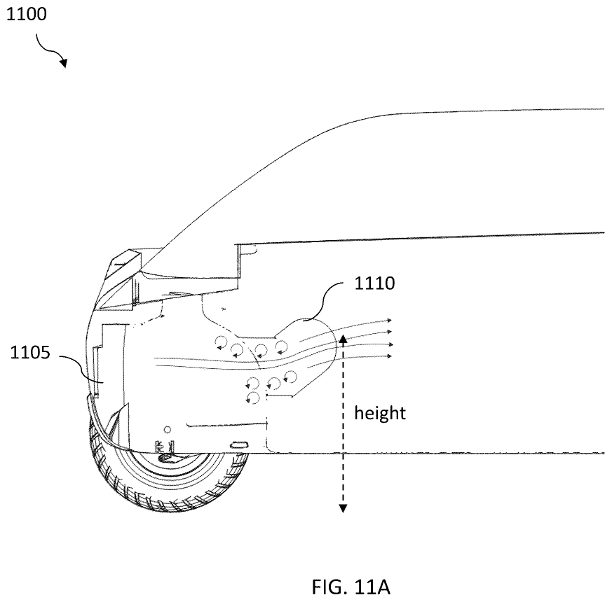

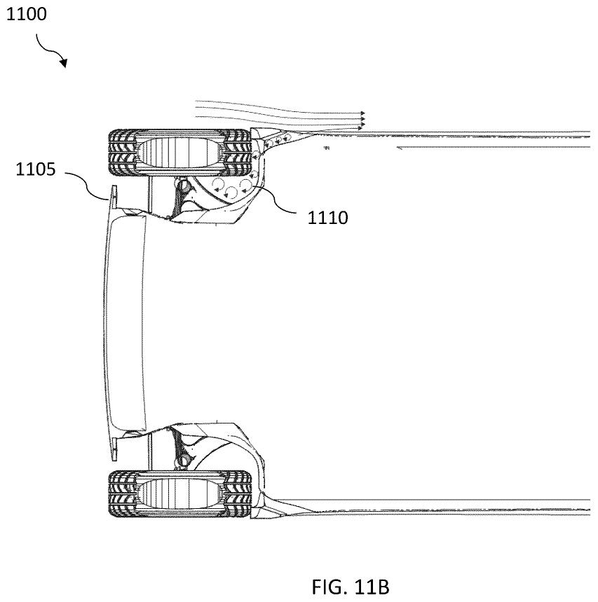

As described herein, the cab 1020 of the electric truck 100, 170 may include side vents 160 that facilitate the flow of air from a front of the electric truck 100, 170 and out of the sides of the cab 120. FIGS. 11A-11B are diagrams illustrating a venting system 1100 for an electric truck.

The cab 120 may include open air wheel wells 1105, which allow air to enter the front area of the electric truck. A side vent 1110, or breather vent, is disposed or located at a height that is above and to the right of the front wheel. For example, the height is based on the wheel and is located above the wheel well. For example, the height of a lower end of the side vent 1110 may be approximately 6 inches above wheel center, where a height of a center point of the side vent 1110 may be approximately 16 inches above wheel center. In some cases, the side vent 1110 may be positioned at a height that is 6-24 inches above wheel center, in order to facilitate the flow of air.

The height and/or geometry of the side vent 1110 enables a mixing of turbulent air or vortices trapped in the wheel well with laminar air flowing around the electric truck (e.g., flowing past a side of the cab 120 of the electric truck 100). Thus, the side vents 1100, being located and/or positioned at a certain above and with respect to the open air wheel wells (e.g., above a certain distance from wheel center), enables the electric truck to efficiently vent and move air through the front area of the truck and out of the side vents of the cab of the truck.

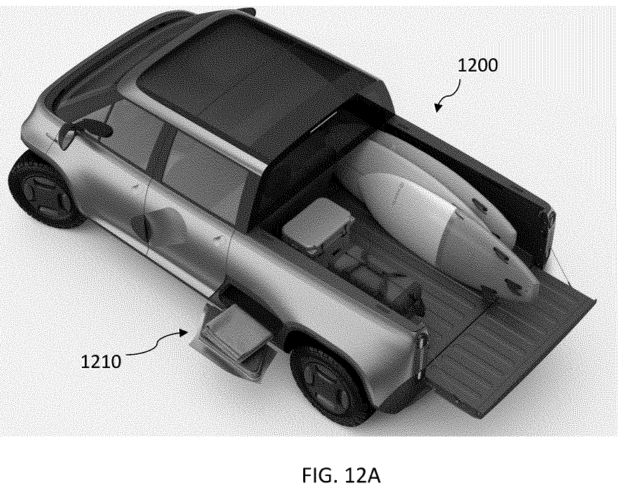

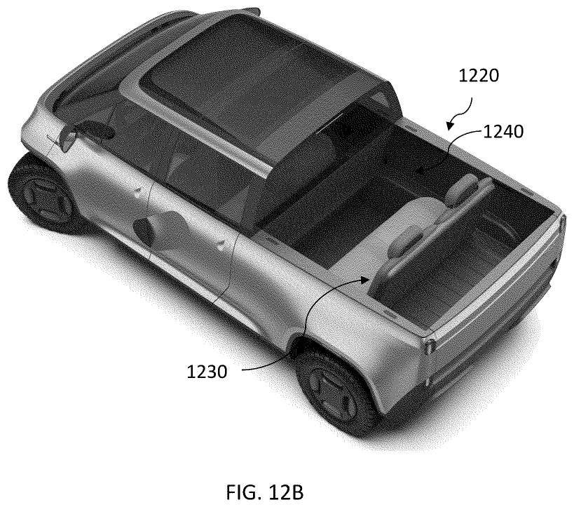

As described herein, the electric truck may include a reconfigurable bed or rear area. FIGS. 12A-12B are diagrams illustrating a reconfigurable bed 1200 for an electric truck. FIG. 12A depicts a bed 1200 in a storage configuration, where a storage compartment 1210 is provided under the bed (e.g., the bed 1200 acts as a cover for the storage compartment 1210). The storage compartment 1210 may span an entire width of the bed (and include entry doors at each side of the truck), and/or the bed may include multiple storage compartments (e.g., one on each side of the truck).

FIG. 12B depicts a bed 1220 in a passenger configuration, where a row of seats 1230 have been added (e.g., under a cap, as described herein). As depicted, a space or opening 1240 under the bed 1220 can provide an area for the legs/feet of passengers in the seats 1230. In some cases, the storage compartment 1210 includes a top or roof component, which can be removed or recessed to provide the opening 1240. Thus, the bed, using the opening under the bed that is provided by the platform described herein, facilitates both storage and passenger seat configurations with an efficient, simple modification of a section of the bed, among other benefits.

### Example Embodiments of the Disclosed Technology

The electric truck and various systems and methods described herein may be implemented as follows.

In some embodiments, an electric vehicle (e.g., an electric truck) comprises a platform or chassis, wherein the platform or chassis includes a front area including two front wheel wells connected by at least one front straight frame extrusion, a rear area including two rear wheel wells connected by at least one rear straight frame extrusion, and right and left straight frame extrusions that connect the front area of the platform to the rear area of the platform.

In some cases, the front area includes a first front straight frame extrusion that connects a top portion of a right front wheel well to a top portion of a left front wheel well, and a second front straight frame extrusion that connects a lower portion of the right front wheel well to a lower portion of the left front wheel well.

In some cases, the front area includes a third front straight frame extrusion that connects a front portion of the right straight frame extrusion to a front portion of the left straight frame extrusion.

In some cases, the front area further comprises a steering assembly that is mounted to the first front straight frame extrusion.

In some cases, the front area further comprises a motor package that is mounted below the second front straight frame extrusion.

In some cases, the electric vehicle includes a front motor package disposed below the at least one front straight frame extrusion of the front area, a rear motor package disposed between the two rear wheel wells of the rear area, and an electric battery disposed between the right and left straight frame extrusions of the platform.

In some cases, the electric vehicle includes a primary bumper beam, a secondary bumper beam disposed below the primary bumper beam, energy absorbers coupled to the primary bumper beam and the secondary bumper beam, a motor package positioned proximate to the secondary bumper beam, and a subframe that is coupled to the motor package.

In some cases, the electric vehicle includes a spine that is coupled to the right and left straight frame extrusions, wherein the subframe includes a first shearable component that couples a top portion of the motor package to the spine component and a second shearable component that couples a bottom portion of the motor package to the spine component.

In some cases, the subframe causes the motor package to rotate and translate towards a bottom area of the platform when the primary bumper beam and the secondary bumper beam receive forces during a collision of the electric vehicle with an object.

In some embodiments, a method performed by a safety system of an electric truck comprises determining a potential collision event with an object proximate to the electric truck, identifying the object proximate to the electric truck, and performing a safety action based on the identification of the object proximate to the electric truck.

In some cases, determining a potential collision event with an object proximate to the electric truck includes determining a time to collision (TTC) associated with the object proximate to the electric truck satisfies a threshold TTC value for performing a safety action.

In some cases, identifying the object proximate to the electric truck includes capturing information about the object using light detection and ranging (Lidar) sensors.

In some cases, identifying the object proximate to the electric truck includes receiving a three-dimensional point cloud image that represents the object, and identifying the object based on the three-dimensional point cloud image.

In some cases, performing the safety action includes deploying an external airbag at a rate that is based on the identification of the object.

In some cases, performing the safety action includes deploying multiple external airbags based on the identification of the object.

In some cases, performing the safety action includes deploying an array of external airbags based on the identification of the object, including deploying a first airbag at a first time, and deploying a second airbag at a second time later than the first time.

In some cases, performing the safety action includes deploying multiple safety devices, including an external airbag, a seat track load limiter, and an internal safety cell.

In some cases, determining the potential collision event includes determining a collision event based on time to collision (TTC) information associated with the object, likelihood of collision (LoC) information associated with the object, and size of collision (SoC) information associated with the object.

In some embodiments, an electric truck comprises a platform that supports a motor package, a battery package, a steering package, and passenger seats, two front wheel wells coupled to a front area of the platform, wherein the two front wheel wells are open to a front of the electric truck, a cab mounted to the platform, and a side vent disposed on each side of the cab, wherein the side vent is disposed at a height that is at least six (6) inches above wheel center of the two front wheel wells.

In some cases, each side vent has a geometry configured to cause turbulent air or vortices trapped in a wheel well to mix with laminar air flowing around the electric truck.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An electric vehicle, comprising:
a platform, wherein the platform includes:
a front area including two front wheel wells connected by at least one front straight frame extrusion;
a rear area including two rear wheel wells connected by at least one rear straight frame extrusion; and
right and left straight frame extrusions that connect the front area of the platform to the rear area of the platform.

2. The electric vehicle of claim 1, wherein the front area includes:
a first front straight frame extrusion that connects a top portion of a right front wheel well to a top portion of a left front wheel well; and
a second front straight frame extrusion that connects a lower portion of the right front wheel well to a lower portion of the left front wheel well.

3. The electric vehicle of claim 2, wherein the front area includes a third front straight frame extrusion that connects a front portion of the right straight frame extrusion to a front portion of the left straight frame extrusion.

4. The electric vehicle of claim 2, wherein the front area further comprises:
a steering assembly that is mounted to the first front straight frame extrusion.

5. The electric vehicle of claim 2, wherein the front area further comprises:
a motor package that is mounted below the second front straight frame extrusion.

6. The electric vehicle of claim 2, further comprising:
a front motor package disposed below the at least one front straight frame extrusion of the front area;
a rear motor package disposed between the two rear wheel wells of the rear area; and
an electric battery disposed between the right and left straight frame extrusions of the platform.

7. The electric vehicle of claim 1, wherein the front area includes:
a primary bumper beam;
a secondary bumper beam disposed below the primary bumper beam;
energy absorbers coupled to the primary bumper beam and the secondary bumper beam;
a motor package positioned proximate to the secondary bumper beam; and
a subframe that is coupled to the motor package.

8. The electric vehicle of claim 7, further comprising:
a spine that is coupled to the right and left straight frame extrusions, wherein the subframe includes:
a first shearable component that couples a top portion of the motor package to the spine component;
a second shearable component that couples a bottom portion of the motor package to the spine component.

9. The electric vehicle of claim 8, wherein the subframe causes the motor package to rotate and translate towards a bottom area of the platform when the primary bumper beam and the secondary bumper beam receive forces during a collision of the electric vehicle with an object.

10. A method performed by a safety system of an electric truck, the method comprising:
determining a potential collision event with an object proximate to the electric truck;
identifying the object proximate to the electric truck; and
performing a safety action based on the identification of the object proximate to the electric truck.

11. The method of claim 10, wherein determining a potential collision event with an object proximate to the electric truck includes determining a time to collision (TTC) associated with the object proximate to the electric truck satisfies a threshold TTC value for performing a safety action.

12. The method of claim 10, wherein identifying the object proximate to the electric truck includes capturing information about the object using light detection and ranging (Lidar) sensors.

13. The method of claim 10, wherein identifying the object proximate to the electric truck includes:
receiving a three-dimensional point cloud image that represents the object; and
identifying the object based on the three-dimensional point cloud image.

14. The method of claim 10, wherein performing the safety action includes deploying an external airbag at a rate that is based on the identification of the object.

15. The method of claim 10, wherein performing the safety action includes deploying multiple external airbags based on the identification of the object.

16. The method of claim 10, wherein performing the safety action includes deploying an array of external airbags based on the identification of the object, including:
deploying a first airbag at a first time; and
deploying a second airbag at a second time later than the first time.

17. The method of claim 10, wherein performing the safety action includes deploying multiple safety devices, including an external airbag, a seat track load limiter, and an internal safety cell.

18. The method of claim 10, wherein determining the potential collision event includes determining a collision event based on:
time to collision (TTC) information associated with the object;
likelihood of collision (LoC) information associated with the object; and
size of collision (SoC) information associated with the object.

19. An electric truck, comprising:
a platform that supports a motor package, a battery package, a steering package, and passenger seats;
two front wheel wells coupled to a front area of the platform,
wherein the two front wheel wells are open to a front of the electric truck;
a cab mounted to the platform; and
a side vent disposed on each side of the cab,
wherein the side vent is disposed on each side of the cab, wherein the side vent is disposed at a height that is at least six inches above wheel center of the two front wheel wells.

20. The electric truck of claim 19, wherein each side vent has a geometry configured to cause turbulent air or vortices trapped in a wheel well to mix with laminar air flowing around the electric truck.
